(19) United States
(12) Patent Application Publication
(10) Pub. No.: US 2005/0193056 A1
(43) Pub. Date: Sep. 1, 2005

(54) Message transfer using multiplexed connections in an open system interconnection transaction processing environment

(76) Inventors: Diane E. Schaefer, North Wales, PA (US); Stephen A. Burdeau, Phoenixville, PA (US)

Correspondence Address: UNISYS Corporation;Attn: Lise A. Rode, Unisys Way MS/E8-114, Blue Bell, PA, 19424-0001, US

(21) Appl. No.: 10/329,723

(22) Filed: Dec. 26, 2002

(51) Int. Cl. G06F 15/16

(52) U.S. Cl. 709/203

(57) ABSTRACT

Novel message formats for use in a distributed transaction environment are disclosed. Each message includes a message type field, a message length field, and a data field, typically in the foregoing order, and each field in the message has a fixed number of bytes. The message type and data length fields may be comprised of a single header. The data field may include novel groups of OSI TP PDUs where each grouping characterizes the content of the data in the PDU. A novel apparatus for use in a distributed transaction environment also is disclosed. The apparatus may include a peer processing machine and a multiplexed TCP/IP connection for exchanging messages with other peer processing machines in the distributed transaction environment.

### I. BACKGROUND

A. Field of the Invention

The invention relates generally to distributed transaction processing systems, and more particularly to improved message transfer and more efficient processing in an open system interconnection (“OSI”) transaction processing (“TP”) environment.

B. Copyright Notice/Permission

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below, the drawings, and any appendices: Copyright. COPYRGT. 1998-2002, Unisys Corporation.

C. Description of the Related Art

Much of the art related and background associated with the invention is described in U.S. Pat. No. 6,141,679, issued on Oct. 31, 2000 and assigned to the assignee of this invention, and its entire contents is incorporated herein by reference. For ease of reference though, some of the information contained therein is set forth below, together with additional information about the shortcomings in the prior art overcome by this invention.

On-line transaction processing (OLTP) is a technology that has been used successfully for business-critical applications by large enterprises for many years. With OLTP, users at terminals send messages to application programs, and these in turn update databases in real time. This is in contrast to batch or queued processing of transactions where the transactions are processed at a later time.

Distributed Transaction Processing (DTP) is a form of on-line transaction processing that allows a single transaction to be performed by multiple application programs that access one or more databases on one or more computers across a network. This type of transaction, in which multiple application programs cooperate, is called a distributed transaction. Using DTP, for example, related databases at regional and branch locations can be synchronized. DTP also facilitates transaction processing across multiple enterprises. For example, DTP can be used to coordinate the computers of manufactures and suppliers, or to coordinate the computers of enterprises in related industries, such as the travel agency, airline, car rental, and hotel industries.

Transaction processing in a distributed environment can be either non-global or global. In a non-global transaction, the same work takes place as in a traditional transaction, but the work is distributed in a client/server manner. For example, a travel agent may request an airline reservation via a client application program that has a graphical user interface. The client application program communicates with a server application program that manages the reservation database. The server application program updates the database, commits or aborts its own work, and returns information to the client application program, which notifies the travel agent.

A global transaction consists of multiple, coordinated database updates, possibly occurring on different computers. Global transactions are used when it is important that all databases are synchronized so that either all updates are made or none are made. Continuing with the previous example, the travel agent may also need to reserve a rental car and hotel room. The customer who is traveling wants to make sure that all reservations are coordinated; if a flight is unavailable, the hotel and car reservations are not needed. For the purpose of illustrating a global transaction, the airline, car, and hotel databases are on different transaction processing systems.

The global transaction begins when the travel agent requests the reservation from a workstation client application program with a graphical user interface. The client program contacts three server application programs on different transaction processing systems. One server program books a flight, another reserves a car, and the third makes a hotel reservation. Each of the server application programs updates its respective database. The transactions processed by each of the server application programs may be referred to as subordinate transactions of the global transaction. A global transaction manager coordinates the updates to the three databases, and a subordinate transaction manager on each of the individual transaction processing systems coordinates locally with the server application programs. The server application programs return information to the client application program.

A major advantage of global transaction processing is that tasks that were once processed individually are processed as a group, the group of tasks being the global transaction. The database updates are made on an all-or-nothing basis. For example, if an airline seat is not available, the hotel and car reservations are not made. Thus, with a global transaction, tasks that were once performed independently may be coordinated and automated.

As with non-global transactions, global transactions must possess atomicity, consistency, isolation, and durability (“ACID”) properties as well. In order to preserve these properties for a global transaction, the commit processing is modified to a two-phase commit procedure. Under a two-phase commit, a global transaction manager first requests that each of the subordinate transaction managers prepare to commit their updates to the respective databases. If all the local transaction managers respond that they are prepared to commit, the global transaction manager sends a commit request to the local transaction managers. Thus, the two parts of the two-phase commit process are (i) prepare to commit the database updates, and (ii) commit the database updates. If any one of the transaction managers is unable to prepare to commit, the entire global transaction is aborted and each transaction manager performs a rollback function to undo the processing that may have occurred up to that point. In short, the two-phase commit process ensures that multiple databases participating in a single global transaction are synchronized—either all database updates requested by the global transaction are made or, in the event of system or component failure, none are made. Two-phase commit guarantees global data integrity and preserves the ACID properties in a DTP environment.

An industry consortium of users and vendors, known as X/Open GroupTM., developed some time ago a model architecture for DTP, referred to as the X/Open Distributed Transaction Processing model. The X/Open DTP model is a software architecture that allows multiple application programs to share resources provided by multiple resource managers, and allows their work to be coordinated into global transactions. The X/Open DTP model comprises a number of components, application programming interfaces (“APIs”), and communications interfaces.

The components of the X/Open DTP model include an application program (“AP”), one or more resource managers (“RMs”), a transaction manager (“TM”), and a communications resource manager (“CRM”). An AP is a user-defined software component that defines global transaction boundaries and specifies actions that constitute global transactions. It also provides access to one or more resources that are required by a transaction. In a global transaction, two or more server APs perform their individual functions which, when combined, make up the global transaction. One of the APs will be the transaction coordinator, that is, the AP that starts and finishes the global transaction. The other APs will be subordinate. A RM provides access to a resource for an AP. Database management systems and file access systems are examples of system software components that act as RMs.

The APs begin and end transactions under the control of a TM. The TM is a system software component that assigns transaction identifiers to global transactions, monitors their progress, coordinates their completion, and coordinates failure recovery. The TM enforces the transaction property of atomicity. In a global transaction, the TM adheres to the two-phase commit transaction processing protocol. A CRM controls communication between the APs that are participating in global transactions, as well as between the TMs on separate data processing systems.

The X/Open DTP model provides a number of standard APIs that enable APs to interact with system components to conduct global transactions. These APIs include one or more AP-RM interfaces, an AP-TM interface, an AP-CRM interface, an RM-TM interface, and a TM-CRM interface. The AP-RM interfaces provide APs access to resources (such as databases) through their respective RMs, but are not specifically defined by the X/Open DTP model, as a number of different resources may exist on a system. Examples of AP-RM interfaces include the Structured Query Language (SQL) and the Indexed Sequential Access Method (ISAM).

The AP-TM interface is provided by the TM to define global transaction boundaries. The AP-TM interface is also referenced as the TX interface. Further information on the TX interface is available in Distributed Transaction Processing: The TX (Transaction Demarcation) Specification, X/Open Company Limited, U.K., (1992).

The AP-CRM interfaces are provided by a CRM to an AP. The X/Open DTP model supports the following three AP-CRM interfaces: the TXRPC interface, the XATMI interface, and the CPI-C interface. Each of these interfaces can be used to enable communication between APs that utilize the same interface. The TM-RM interface is used for purposes of transaction control (preparing, committing, or rolling-back). The TM-RM interface is described further in XA Interface, Distributed Transaction Processing: The TX (Transaction Demarcation) Specification, X/Open Company Limited, U. K. (1992). The TM-CRM interface 29 is described further in X/Open Preliminary Specification--Distributed Transaction Processing: The XA+ Specification, X/Open Company Limited, U.K. (1993). The XATMI interface is described in more detail below, as well as in Distributed Transaction Processing: The XATMI Specification, X/Open Company Limited, U.K., (1993) (hereinafter “the XATMI Specification”) which is incorporated herein by reference in its entirety.

In addition to the foregoing APIs, systems that implement the X/Open DTP model can communicate with each other using an industry standard communications protocol know as Open Systems Interconnection (OSI) Transaction Processing (TP) (ISO/IEC 10026) (“the OSI TP Standard”), all parts of which are hereby incorporated by reference in their entireties. The OSI TP Standard defines a machine independent protocol that supports communications between computers in a transaction processing system. An industry standard CRM-OSI TP programming interface, called XAP-TP, provides an interface between a CRM and an OSI TP protocol machine that conforms to the OSI TP Standard. ISO/IEC 10026-3, Information Technology—Open Systems Interconnection—Distributed Transaction Processing—Part 3: Protocol Specification (“the OSI TP Protocol Specification”) defines the state transitions and protocols that a conformant OSI TP protocol machine must generate in processing OSI TP service requests in accordance with the OSI TP Standard. The XAP-TP programming interface is specified in X/Open ACSE/Presentation: Transaction Processing API (XAP-TP) CAE specification (“the XAP-TP Specification”). The XAP-TP Specification defines the interface, including functions, parameters, and errors, that controls the use of a conformant OSI-TP protocol machine.

The XATMI interface relies principally on the following API requests supported by the TX interface: tx.sub.—begin( )—a demarcation function that indicates that subsequent work performed by the calling AP is in support of a global transaction; tx.sub.—commit( )—a demarcation function that commits all work done on behalf of the current global transaction; and tx.sub.—rollback( )—a demarcation function that rolls back all work done on behalf of the current global transaction. Further details of the TX interface can be found in Distributed Transaction Processing: The TX (Transaction Demarcation) Specification, X/Open Company Limited, U.K., (1992).

The XATMI API provides a set of function calls, collectively referred to as the tp*( ) function calls, that can be called to perform various functions. Table 1 is a list of these functions, callable from any C language application program:

TABLE 1
Service Requests (Function Calls) of the XATMI API.

| | |
|---|---|
| Name | Description |

Typed Buffer Functions

| | |
|---|---|
| tpalloc( ) | Allocate a typed buffer. |
| tpfree( ) | Free a typed buffer. |
| tprealloc( ) | Change the size of a typed buffer. |
| tptypes( ) | Determine information about a typed buffer. |

Functions for Writing Service Routines

| | |
|---|---|
| tpservice( ) | Template for service routines. |
| tpreturn( ) | Return from a service routine. |

Functions for Dynamically Advertising Service Names

| | |
|---|---|
| tpadvertise( ) | Advertise a service name. |
| tpunadvertise( ) | Unadvertise a service name. |

Functions for Request/Response Services

| | |
|---|---|
| tpacall( ) | Send a service request. |
| tpcall( ) | Send a service request and synchronously await its reply. |
| tpcancel( ) | Cancel a call descriptor for an outstanding reply. |
| tpgetrply( ) | Get a reply from a previous service request. |

Functions for Conversational Services

| | |
|---|---|
| tpconnect( ) | Establish a conversational service connection. |
| tpdiscon( ) | Terminate a conversational service connection abortively. |
| tprecv( ) | Receive a message in a conversational connection. |
| tpsend( ) | Send a message in a conversational connection. |

Each of the foregoing XATMI API requests has a formal syntax that specifies the format and arguments of each request. The formal syntax for each request is specified in the XATMI Specification.

The XATMI interface supports typed buffers through the typed buffer functions listed above. A typed buffer contains data and has associated with it a type and possibly a subtype, that indicate the meaning or interpretation of the data. An AP calls tpalloc( ) to allocate a typed buffer of a specified type and subtype, can call tprealloc( ) to increase its size, and must eventually call tpfree( ) to dispose of it. A receiver of a typed buffer can call tptypes( ) to determine the type and subtype of a buffer as well as its size.

Under the X/Open DTP model, the primitives (i.e., function calls) of the XATMI API are mapped to the services of the OSI TP protocol through an abstraction layer referred to as the XATMI Application Service Element (XATMI ASE). The XATMI-ASE defines how the primitives in the XATMI interface (e.g., tpcall, tpacall, tpsend, etc.) are mapped to the services of the OSI TP protocol, the specifics of which may be found in the XATMI Specification.

The XAP-TP programming interface provides the interface between the XATMI-ASE service calls issued by a CRM, and the corresponding OSI TP service calls to which they must be mapped in an OSI TP protocol machine. In fact, some of the XATMI-ASE service primitives map to a combination of more than one OSI TP service. For example, the XATMI-ASE service primitive, XATMI-CALL req, maps to a sequence of three OSI TP service calls, TP-BEGIN-DIALOGUE req, TP-DATA req, and TP-GRANT-CONTROL req. Thus, according to the XAP TP Specification and OSI TP Protocol Specification, the XAP-TP interface must be called three successive times in order to execute the XATMI-CALL req service primitive of the XATMI-ASE, i.e., once for each OSI TP service call to which it maps. Moreover, according to the OSI TP Protocol Specification, each of the OSI TP service calls is processed by the OSI TP protocol machine independently (i.e., one at a time).

In other words, according to the XAP-TP Specification and OSI TP Protocol Specification, a CRM is required to make calls to an OSI TP protocol machine via XAP-TP three separate times in order to perform the services required by the XATMI-CALL req primitive of the XATMI-ASE. Each of these calls enters the OSI TP protocol machine separately, the OSI TP protocol machine makes the necessary state transitions, the OSI TP protocol machine enters a protocol encoder to encode appropriate OSI-TP protocol data units (“PDUs”), as described in the OSI TP Protocol Specification, and the PDUs are eventually sent to the network via the lower layer protocols.

The reason that higher-level services, such as the XATMI-CALL req of the XATMI-ASE, are broken down into more granular service primitives within the OSI TP protocol machine is that the standard OSI TP protocol machine, as specified in the OSI TP Protocol Specification, must support multiple AP-CRM programming interfaces—the XATMI interface described above, the TXRPC interface, the CPI-C interface, and others not yet defined. Combinations of the granular service primitives of the OSI TP Protocol Specification are executed, in sequence, as necessary to perform the higher level services of each AP-CRM interface.

In practice though, the granular nature of the service primitives of the OSI TP Protocol Specification often result in increased system overhead that adversely affects the performance and throughput of any implementation of the OSI TP Protocol Specification. For example, because of the granular nature of the OSI TP Protocol Specification, execution of a single XATMI-ASE service request, such as XATMI-CALL req, requires three separate calls to a standard OSI TP protocol machine via the XAP TP interface. The system must cross the process boundary between the user process (i.e., the software processes executing the functions of the AP, TM, and CRM) and the OSI TP process (i.e., the software processes executing the functions of the OSI TP protocol machine) multiple times. Numerous calls across process boundaries in a software implementation of a system can seriously effect performance of the system.

Many DTP systems only support one of the three available AP-CRM programming interfaces. For example, a DTP system may only support the XATMI interface. Nevertheless, because the OSI TP Protocol Specification was designed with sufficient granularity to support many AP-CRM interfaces the overhead imposed by that granular design cannot be avoided with a fully compliant OSI TP protocol machine.

The invention described and claimed in U.S. Pat. No. 6,141,679 noted above (the “679 model”) addressed the problems associated with the foregoing design by optimizing the operation of an OSI TP based protocol machine for use in a particular AP-CRM interface environment without affecting the conformance of the system to the OSI TP Protocol Specification. Specifically, in the 679 model the multiple OSI TP service requests to which a given service request of the XATMI ASE are mapped, and which are normally processed as individual events in an OSI TP protocol machine that conforms to the OSI TP Protocol Specification, are concatenated and processed by a modified OSI TP protocol machine as a single, atomic event. The modified OSI TP protocol machine comprised a modified multiple association control facility (“MACF”) protocol machine that operated in accordance with a modified MACF state table that defined new event primitives and associated actions to support the processing of concatenated OSI TP services as single, atomic events.

The 679 model modified OSI TP protocol machine also comprised a modified single association control facility (“SACF”) protocol machine that operated in accordance with a modified SACF state table that defined new service primitives that corresponded to the new events defined in the modified MACF state table. The 679 model modified OSI TP protocol machine further comprised means for receiving successive OSI TP PDUs from a peer node until all of the PDUs associated with a particular service of the XATMI ASE protocol specification had been received, concatenating all of the received PDUs associated with that XATMI ASE service, and then passing the concatenated PDUs through the modified OSI TP protocol machine for processing as a single, atomic event.

Finally, to support the processing of concatenated OSI TP services as a single, atomic event in an XATMI ASE environment, the 679 model also included a CRM-OSI TP programming interface, referred to as the high performance transaction processing for XATMI (“HPTPX”) programming interface, which replaced the standard XAP TP programming interface. Each service primitive of the XATMI ASE mapped to a respective, single service request of the HPTPX interface in the 679 model, and each service request of the HPTPX interface represented a concatenation of the OSI TP services to which its respective XATMI ASE service was normally mapped in accordance with the XATMI Specification.

FIG. 1 is a block diagram illustrating the process structure and functional components in a preferred embodiment of the 679 model. Apparatus 80 comprises code 84 that implements the HPTPX interface of the 679 model, and a modified OSI TP protocol machine 85 that, as described above, processes concatenated OSI TP services for a given HPTPX service request as a single, atomic event. An input/output control block 96 and a session block 98 control the input and output of data to and from the modified OSI TP protocol machine 85 via an output thread 102 and one or more input threads 104. The session block 98 performs protocol transformations for the session layer of the OSI protocol stack. A TSU request queue collects outgoing requests for processing by the output thread 102, which sends requests out to the network. An output queue 106 stores flow controlled data requests when the network (not shown) is congested. An implementation of lower layer protocols 108 handles the low level communications between nodes.

The modified OSI TP protocol machine 85 of the 679 model is based on the standard OSI TP protocol machine defined in the OSI TP Protocol Specification, but has been modified to support the processing of certain combinations of concatenated OSI TP service requests as single, atomic events, while remaining fully compliant with the OSI TP Standard. The modified OSI TP protocol machine 85 comprises a modified MACF protocol machine 86, with its associated CPM, and a modified SACF protocol machine 88. Requests to the SACF protocol machine are queued in a SACF storage queue 90. The modified OSI TP protocol machine further comprises a PDU concat function 92.

Control of logging and management of the transaction trees is kept under the control of a TM. The modified MACF protocol machine 86 relinquishes control of branch management to the TM and treats each branch as a separate entity with no correlation to any other branch. The modified OSI TP protocol machine 85 controls all associations needed for TP dialogues and channels. The CRM will solicit the modified OSI TP protocol machine 85 for an AAID when needed, and in the case of added multiple branches to the same transaction tree, it will supply the modified OSI TP protocol machine 85 with the necessary AAID. Recovery is also handled branch by branch. The modified MACF protocol machine 86 does not need to know how the branches are associated. A NULL RCH (recovery context handle) is assumed and incoming association requests are denied until recovery is performed. Once recovery is complete, the RCH is said to be “active”.

FIG. 2 is a block diagram illustrating prior art non-multiplexed connections between hosts in an OSI TP environment, including the 679 model. In an OSI TP environment where Host A 201 and another Host B 202 are exchanging data, there are one or more concurrent dialogues 203a-203x (e.g., XATMI service calls) residing on Host A that correspond directly to one or more concurrent dialogues 204a-204x on Host B. In the prior art, non-multiplexed associations 205a-205x were created between each dialogue 203a-203x on Host A 201 and each dialogue 204a-204x on Host B 202. This involved significant codepath, generated excess overhead, and made connection management and creation difficult and complex.

Despite the 679 model's significant advances over the prior art, the overhead and complexity associated with OSI TP Protocol Specification continues to detrimentally effect system performance in fully compliant OSI TP protocol machines. Accordingly, there is a need for a DTP system and model where less data is exchanged, fewer discrete components are used, and unnecessary protocol options are eliminated.

### II. SUMMARY OF THE INVENTION

The invention overcomes problems with the prior art in a number of ways. First, the invention provides a novel mapping of the OSI TP PDUs that is less complex, requires less system overhead, and results in simpler connection creation and management. Moreover, the novel PDU mappings are platform and hardware independent. Each mapping groups the OSI PDUs into types that characterize the PDUs' content, thereby minimizing the number of processing cycles expended on each PDU because the processor need not interpret each field of every PDU the processor receives. In one embodiment of the invention, the mappings are customized and optimized for an OSI TP machine utilizing XATMI.

Another aspect of the invention is the use of multiplexed TCP/IP protocol connections to transfer messages between TMs in OSI TP environments. Through the use of multiplexed TCP/IP connections in the OSI TP protocol machine the SACF and OSI lower layers in the prior art may be eliminated, significantly reduced codepath is necessary, less overhead related to data transfer is required, and there are hardware independent connections that are far simpler to create and manage.

In general, the invention eliminates portions of the OSI TP stack design and condenses network transmission to multiplexed TCP/IP connections, condenses the TCP IP protocol stack and moves the functions of the SACF and CCR in the prior art into the MACF and reworks the encode and decode routines into fixed buffers that are consistent with XATMI. Other aspects of the invention, together with additional features and advantages are described below.

### III. BRIEF DESCRIPTION OF THE DRAWINGS

These and other features, aspects, and advantages of the invention will become better understood in connection with the appended claims and the following description and drawings of various embodiments of the invention where:

FIG. 1 is a block diagram illustrating the process structure and functional components of a prior art apparatus for performing distributed transaction processing in an OSI TP environment;

FIG. 2 is a block diagram illustrating prior art non-multiplexed connections between hosts in an OSI TP environment;

FIG. 3 is a block diagram illustrating multiplexed connections between hosts in an OSI TP environment in accordance with an embodiment of the invention;

FIG. 4 is a block diagram illustrating the process structure and functional components of an apparatus for performing distributed transaction processing in an OST TP environment in accordance with an embodiment of the invention;

FIG. 5 is a block diagram illustrating the layers in a modified OSI TP stack in accordance with an embodiment of the invention; and

FIG. 6 is a state table describing multiplexing OSI TP messages over a TCP-IP connection in accordance with an embodiment of the invention.

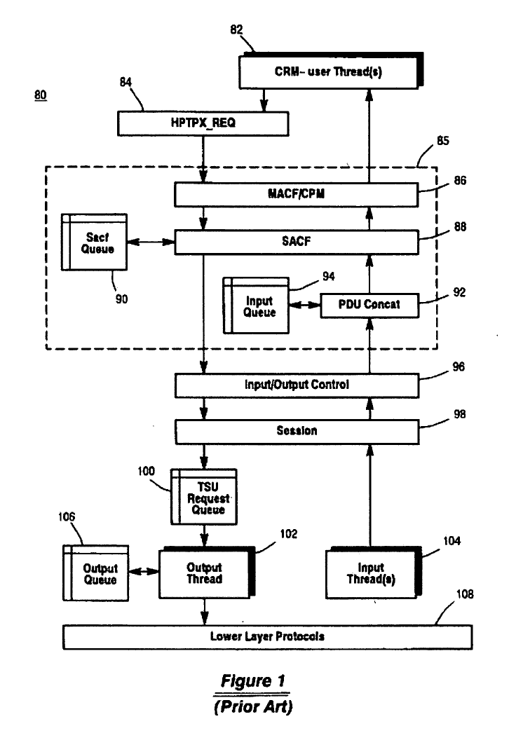

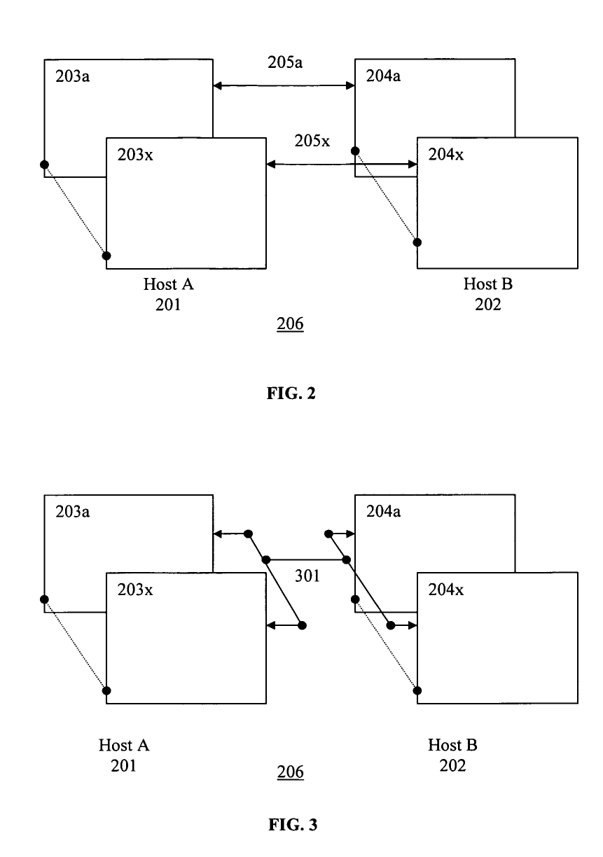

### IV. DETAILED DESCRIPTION OF THE ILLUSTRATED EMBODIMENTS

Throughout the following detailed description similar reference numbers refer to similar elements in all the Figures.

FIG. 3 is a block diagram illustrating multiplexed connections between the same pair of hosts in an OSI TP environment in accordance with an embodiment of the invention. As with the prior art, in an OSI TP environment where Host A 201 and another Host B 202 are exchanging data, there are one or more concurrent dialogues 203a-203x (e.g., XATMI service calls) residing on Host A that correspond directly to one or more concurrent dialogues 204a-204x on Host B. In departure from the prior art, rather than utilizing non-multiplexed associations between Host A and Host B, a single multiplexed TCP/IP connection 301 connects Host A 201 to Host B 202. Data being exchanged between the concurrent dialogues 203a-203x on Host A 201 and the concurrent dialogues 204a-204x on Host B 202 is mapped into the single multiplexed TCP/IP connection 301 between Host A 201 and Host B 202.

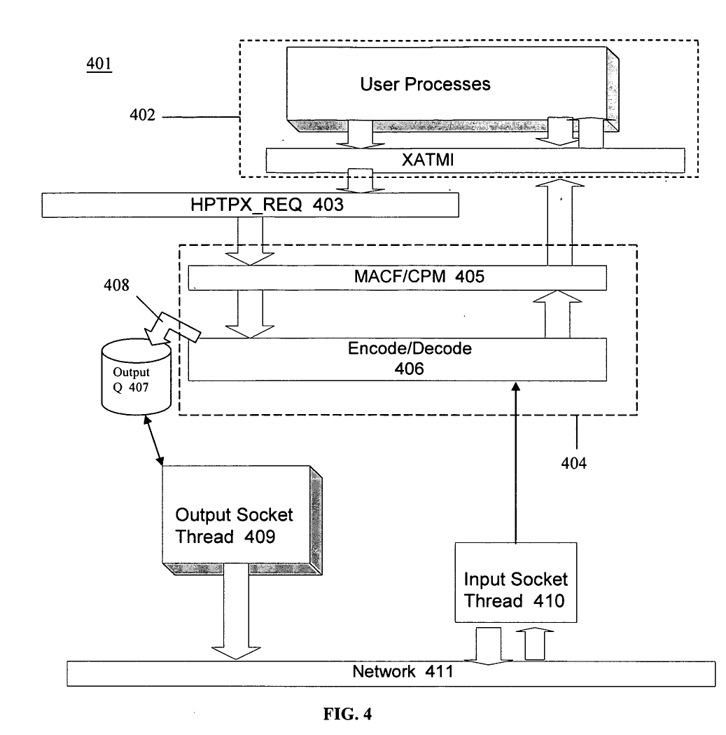

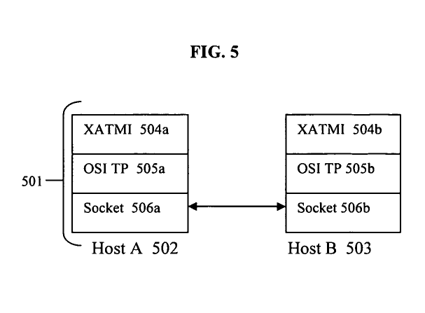

FIG. 4 is a block diagram illustrating the process structure and functional components of an apparatus 401 for performing distributed transaction processing in an OST TP environment in accordance with an embodiment of the invention. Apparatus 401 comprises code 403 that implements the HPTPX interface, and a modified OSI TP protocol machine 404 that processes concatenated OSI TP services for a given HPTPX service request as a single, atomic event. An output queue 407 holds all requests 408 from the modified OSI TP protocol machine. Output socket thread 409 takes all requests 408 from queue 407, and distributes them to the one or more remote host buffers (not shown) it controls where it is sent to the remote host. Data from network 411 is input to the modified OSI TP protocol machine 404 via input socket thread 410.

The modified OSI TP protocol machine 404 of apparatus 401 is based on the standard OSI TP protocol machine defined in the OSI TP Protocol Specification, and/or as modified by the 679 model noted above, but has been further modified to support the processing of messages that are much simpler in form. The format and handling of these simpler messages is described in detail below. The modified OSI TP protocol machine 404 comprises a modified MACF protocol machine 405, with its associated Channel Protocol Machine (CPM), and an encode/decode machine 406. Data as it flows from the MACF/CPM protocol machine 405 to the XATMI engine in 402 remains consistent with XATMI standard X/Open protocol.

The threads utilized in the multiplexed OSI TP over TCP/IP environment of apparatus 401 have the following characteristics. A Timer Thread deals with timed events, such as recovery and cleanup of resources. A Socket Listener Thread listens for incoming connection requests on any of the IP/Port combinations configured in the apparatus 401. In one embodiment the user may configure up to 8 listening addresses, thereby allowing for multi-homing. Socket Worker Threads are designated once a incoming association request is received by apparatus 401, and receive all other data from the other host after the incoming association request. A Socket Input Thread listens on all sockets in apparatus 401 for incoming data, and there is one input thread for each remote host configured by apparatus 401. Each socket input thread controls two basic structures in apparatus 401, a Communications Instance Array and a Poll Array, which match socket requests to Multiplexed Communications Instances (“MCIs”). Each socket input thread reads data for all sockets in the poll array, and captures and interprets the message headers in the data read. If the header is either a Keep_Alive, Keep_Alive_Ok, or Security_Ok, described in more detail below, the socket input thread performs all the necessary processing. Otherwise, the header and data (based on the length) are moved to the appropriate Stream Input Queue for the Communications Instance. A Socket Output Thread controls the flow of PDUs from the output queue 407 to the write buffer, and streams data from the write buffer onto the network 411. The Asynchronous Request Processor (ARP) Thread handles asynchronous requests depending on the particular implementation.

Two novel data structures are utilized in the multiplexed TCP/IP connection aspects of the apparatus 401 embodiment of the invention. The first, mentioned above, is the MCI. There is one MCI per remote host connection. The MCI represents the state of the connection and all information needed to establish communications, send, and receive data to and from the particular remote host. In one embodiment of the invention, there are two buffers associated with each MCI. One of the buffers is where the socket threads stream the data to be read from the socket and the other buffer is for data to be written to the socket. State of the multiplexed TCP/IP connection also is maintained in the MCI. In one embodiment of the invention the recognized states comprise idle (i.e., no connection exists), connecting (i.e., connection establishment in progress), connected (connection is established), and reconnecting (i.e., connection was broken and is waiting to be re-established). There may also be sub-states associated with the connection to control security and keep the connection alive. For example, security sub-states could include: no_security, wsecure_ack, wsecure_rc, and secure. Keep alive sub-states could include: kalive-pending, and kalive-ok.

FIG. 6 illustrates one implementation of a state table 601 for use with the apparatus 401 embodiment of the invention. Events addressed in state table 601 include: Mconnect-req (request for multiplexed connection); Mdata-req (request to send data over multiplexed connection); Accept-connect (incoming connection request received); Assoc-rsp (response to an outgoing association was received); and Connection-close (physical connection was closed or aborted). Actions addressed in state table 601 include: SEND-ASSOC-REQ (processes an outgoing association request after first establishing a TCP/IP connection and then encoding and sending an Associate_Req to the peer host); HELD-Q (queues messages to a held queue until they can be sent to the peer host); SEND-DATA (sends messages to the peer host over the TCP/IP connection); SEND-ASSOC-RSP (accepts incoming Associate_Req message and encodes and sends Associate_Rsp message to the peer host over the multiplexed TCP/IP connection); SEND-ABORT-REQ (rejects an incoming Associate_Req message and encodes and sends an Abort_Req message); CLOSE-SOCKET (closes socket with incoming connection and causes a peer host to see a Connection-close event); FLUSH-Q (writes all messages stored in held queue to a peer host over the TCP/IP connection); DISCARD-Q (frees all messages stored in held queue); RECOVER-MACF (alerts MACF to a Connection-close event and processes provider abort actions); MRECONNECT (uses Timer thread to sleep for a period of time and then raises a Mconnect-req event); and UPDATE-LSN (generates a new random integer for the variable LSN). Decisions addressed in the FIG. 6 state table include Validation True (“VT”), which indicates that all received fields in a message have been successfully validated. Variables addressed in the FIG. 6 state table include: Local Serial Number (“LSN”) (a randomly generated unsigned long integer stored in an MCI); and Remote Serial Number (“RSN”) (a randomly generated unsigned long integer from the remote system found in an incoming Associate_Req message).

Each MCI may have a serial number comprised of a random number assigned to it when an Associate Request is sent. The serial number may serve several purposes, such as resolving association establishment collisions. Each MCI also may maintain various statistics, such as size of transfer and how many PDUs are being sent. The statistics may be used for a number of purposes, one example being adjustments in the streaming of data.

Each MCI also may have remote host information, such as the OSI TP application entity title and IP address information needed to make the particular TCP/IP connection. The MCI may also contain a pointer to such information. Finally, each MCI also may include protocol version information and security information, such as HASH values for use in security exchanges.

The other novel data structure utilized in the multiplexed TCP/IP connection aspects of apparatus 401 is the Multiplexed Branch (“MB”) data structure. While containing information from the prior art XBRANCH_TEMPLATE data structure, in one embodiment of the invention each MB data structure includes the following additional information: a pointer to its associated MCI for queuing output requests and posting network aborts from its MCI; decoded fields which serve as a place to put any flags or other information discovered while decoding a PDU; and a serial number comprised of the branch and gen-id of the remote host corresponding message so that when a message arrives at apparatus 401 the socket input thread can find the appropriate branch record in apparatus 401.

Data movement, connection behavior, and the like in the apparatus 401 embodiment of the invention can generally be described as follows. There is one thread that controls sending and receiving of messages per remote host. One connection is established and maintained between the apparatus 401 and the remote host session by this worker thread. Once a connection to a remote host is established, it remains available until it is abnormally terminated due to a network or host failure.

One listening thread is activated upon startup of apparatus 401 and listens for incoming connection requests. As noted above, in one embodiment of apparatus 401 there may be up to 8 IP addresses with ports specified for the listening thread to wait for incoming messages from remote hosts. Once a message is received, apparatus 401 starts a worker thread to analyze the incoming message, send the response, and handle all future incoming communication with this peer. This worker thread exists for the duration of the socket. There is a collision scenario that exists where an output and input connection establishment is attempted. In this case apparatus 401 maintains an internal serial number for each connection attempt so results can be compared and one side or the other will “win” the connection establishment. Once connection 301 is established, data may flow from either side. If connection 301 is established from the apparatus 401 side, the output thread determines that a connection establishment is needed and starts a worker thread to create connection 301 and handle all future incoming communication with the peer.

There is one output thread that handles the transmission of all output messages. The output thread works from output queue 407 where messages coming from protocol machine 404 are placed. Data is not copied in this case, but referenced from the queue. Additional headers are needed by OSI TP so that the peer will recognize the data format. These additional headers are generated by MACF 405 and sent in a separate array to output queue 407 along with the user data and the internal representation of what resource has sent the message and what remote host this message is destined for. When output thread 409 wakes up, it takes all messages accumulated on queue 407 from all CRM 402 application threads and begins to gather the output data to be placed on the multiplexed OSI TP over TCP/IP connection 301. The messages are separated by remote host and sent as a gathered output. The CRM 402 application thread is held until the data is actually sent. This enables apparatus 401 to send data directly from the CRM 402 generated buffer without copying the data.

Once connection 301 is established, there is a dedicated worker thread to handle incoming messages for this connection. When a message is received, the contents are evaluated based on the message type as described in detail below. XATMI messages are passed up through protocol machine 404 for state processing before the actual message is passed up to CRM 402. The array used to receive the message is simply indexed into at various points depending on which software piece of apparatus 401 needs to reference the array. Some inbound messages are not destined for CRM 402 and result in an immediate outbound response generated by the input worker thread (instead of being placed on the output queue for the output thread to process).

When a network failure or socket close is detected, apparatus 401 begins its failure processing for all resources using connection 301 to communicate with remote hosts or the particular remote host associated with the closed socket. All active calls are aborted and depending on their current state may enter into transaction recovery. In transaction recovery, apparatus 401 tries to reestablish communication with the remote host or hosts and assess the current state of the transaction. The connection layer handles actually re-establishing communications while all messages destined for the remote host or hosts are held by apparatus 401. Once the communications are re-established, all query requests are sent so the transaction can be resumed. In one embodiment of apparatus 401, connection layer 301 attempts to reestablish communications using the graduated time algorithm shown in Table 2 below:

TABLE 2

| For this amount | |
|---|---|
| Of time . . . | Retry this often |
| 6 min | 20 seconds |
| 1 hr | 1 minute |
| 10 hr | 10 minutes |
| 1 day | 20 minutes |
| 1 week | 1 hour |
| 1 month | 2 hours |

A socket close results in all held data being flushed and aborts being sent to all active transactions. CRM 402 only sees aborts for transactions in the active phase. Once a transaction has been prepared, recovery attempts continue indefinitely until they are resolved.

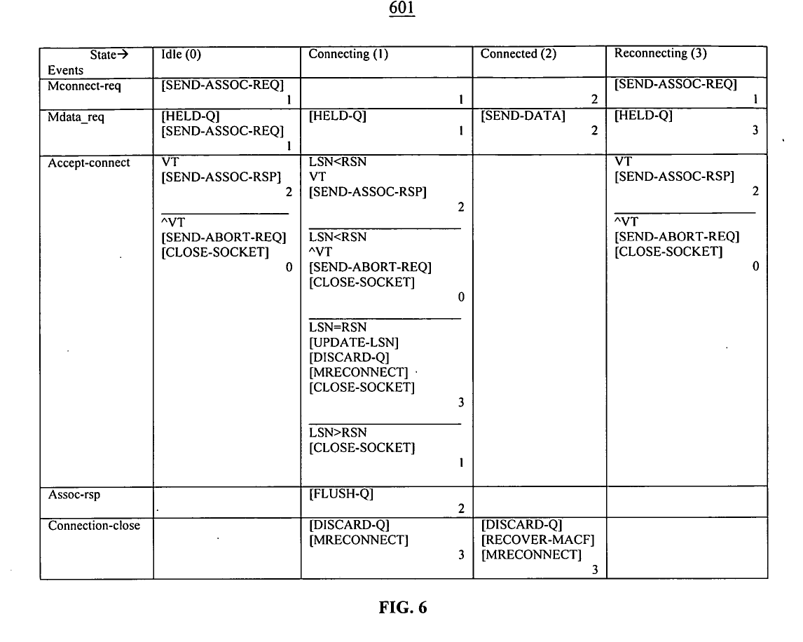

Another aspect of the invention noted above is the format of the OSI TP messages exchanged in an OSI TP distributed transaction processing environment. In accordance with the invention the OSI TP messages are simplified and shortened. Rather than employing the standard ASN.1 encoding of the prior art, a much simpler form of encoding is utilized in the invention. Simple messages are defined for each data exchange, and each message has fixed parameters. The transport, session, and presentation layers in the prior art are eliminated and data is streamed onto the network directly. Each message is complete, and contains a message type and message length followed by the rest of the message, unlike the prior art where each variable subcomponent consisted of a designated type, data, length and value. In this case all subcomponents are identified and placed into fix length fields. Thus, each MACF machine in a OSI TP implementation communicates directly with peers or remote hosts, and the standard seven-layer OSI model is reduced by eliminating presentation, session and the OSI transport protocol layers to the layers as shown in FIG. 5.

As shown in FIG. 5, the modified OSI TP stack 501 in one embodiment of the invention comprises an XATMI layer 504a, OSI TP layer 505a, and Socket layer 506a, each of which resides on Host Platform A 502. The same modified stack may reside on other peers or remote hosts such as Host Platform B 503 in FIG. 5. In this simplified model 501 socket layers 506 communicate with each other by establishing a socket connection 507 between the local (e.g., Host Platform A 502) and remote hosts (e.g., Host Platform B 503), sending an ASSOCIATE-REQ with the Application Entity Title (“AET”) to identify the OSI TP layer, confirming the foregoing, and exchanging security information if enabled. When a client issues either a TPCALL or TPCONNECT, the XATMI layers are connected. Through this modified stack, all data and transaction primitives are exchanged.

In accordance with the invention, all messages are simply streams of bytes without regard for word alignment, and each message field is represented by a fixed number of bytes. In a preferred embodiment of the invention the following logical field types are used to encode OSI TP messages: unsigned byte (one 8-bit byte); array of unsigned byte; unsigned short integer (two 8-bit bytes); and unsigned long integer (four 8-bit bytes). In the unsigned short integer field type the first byte is the high order byte and the second byte is the low-order byte. In the unsigned long integer field type the first byte is the highest order byte; the second byte is the next highest order byte, and so on.

The messages in accordance with the preferred embodiment of the invention have the following general format: Header [OSI TP Data [XATMI Encoding [user data]]], where the information contained with any set of brackets is optional. All messages contain a five-byte Header comprised of an unsigned byte that indicates message type and an unsigned long integer that indicates the remaining message length. The format of the OSI TP data varies depending on the particular message, as described in more detail below. The format of the XATMI encoding in accordance with a preferred embodiment of the invention comprises an unsigned long integer that indicates the length of XATMI data in the message and an array of unsigned bytes that is the XATMI data.

The meaning of the message and the format of the remaining portion of the message varies depending on the Message Type, which have been defined to start with the number 16 to avoid any possibility of overlap with the old Request for Comment (“RFC”) 1006 protocol which sends a 3 as the first byte of a message. Table 3 below lists the Message Types in accordance with a preferred embodiment of the invention. In the Table 3 descriptions the terms “recipient” and “local” are from the point of view of the message encoder. When the message is decoded, the meanings of these fields become reversed. For example, the “recipient AET” on an associate request is encoded as the AET for the remote system. When the message is decoded, this same field in the message now represents the AET for the local system. In a preferred embodiment of the invention the Header portion of a message contains a Message Type followed by a data length.

TABLE 3

| Number | Name | Description |
|---|---|---|
| 16 | Keep_Alive | This message type causes a keep alive signal to be |
| | | sent to a remote host to check if the connection is |
| | | still valid. Upon receiving this message, a |
| | | KEEP_ALIVE_OK is sent back. Remaining |
| | | Message Length is 0. |
| 17 | Keep_Alive_Ok | This message type is the response to the keep |
| | | alive message. Remaining Message Length is 0. |
| 18 | Associate_Req | This message type is used to initiate a connection |
| | | with a remote communication instance, and |
| | | carries information in the OSI TP data portion |
| | | that includes platform type, protocol version, |
| | | AET, encryption and multiplexing limits, security |
| | | information, and serial number of the |
| | | communication instance. Remaining Message |
| | | Length is a maximum of 110. |
| 19 | Associate_Rsp | This message type is used to confirm an |
| | | association request, and it carries information in |
| | | the OSI TP data portion that includes the |
| | | negotiated protocol version, negotiated |
| | | multiplexing limits, negotiated encryption key |
| | | size, and security information. Remaining Message |
| | | Length is 27. |
| 20 | Security_Rsp | This message type is used in the final exchange of |
| | | security levels when both sides have security |
| | | turned on, and allows a communication instance |
| | | to begin processing TPCALL/TPCONNECTs |
| | | from clients. Remaining Message Length is 20. |
| 21 | Security_Ok | This message type is used to acknowledge |
| | | security exchange. Remaining Message Length is 0 |
| 22 | New_Dialogue | This message type is reserved for sending new |
| | | dialogues. Remaining Message Length depends |
| | | on the particular OSI TP PDU and the XATMI |
| | | date, as described in more detail below. |
| 23 | Data | This message type is used for everything else that |
| | | is exchanged over a connection. Remaining |
| | | Message Length depends on the particular OSI |
| | | TP PDU and the XATMI data as described in more detail |
| | | below. |
| 24 | Abort_Req | This message type is used to indicate an |
| | | Association abort. Remaining Message Length is 1. |

The format of the OSI TP Data portion of the foregoing Associate_Req message type in accordance with an embodiment of the invention is shown below in Table 4. There is no XATMI Encoding or user data portion for this message type.

TABLE 4

| | |
|---|---|
| Unsigned Byte | Platform type (e.g., 1 = OpenTI; 2 = eLink; |
| | 3 = MCP) |
| Unsigned Byte | Protocol version |
| Unsigned Byte | Multiplexing count |
| Unsigned Byte | Minimum encryption bits (e.g., 0, 40, |
| | 56, or 128) |
| Unsigned Byte | Maximum encryption bits (e.g., 0, 40, |
| | 56, or 128) |
| Unsigned Long Integer | MCI serial number |
| Unsigned Long Integer | Local RN (set to 0 if security not configured) |
| Unsigned Byte | Local AET length (e.g., from 1 to 48) |
| Array of Unsigned Bytes | Local AET |
| Unsigned Byte | Recipient AET length (e.g., from 1 to 48) |
| Array of Unsigned Bytes | Recipient AET |

Encryption bits also may be encoded as enumerated types so that key lengths greater than 255 bits can be represented in a single byte. In the alternative, special case values above 128 can be used to represent key sizes larger than 255 bits.

The format of the OSI TP Data portion of the foregoing Associate_Rsp message type in accordance with an embodiment of the invention is shown below in Table 5. There is no XATMI Encoding or user data portion for this message type.

TABLE 5

| | |
|---|---|
| Unsigned Byte | Negotiated protocol version |
| Unsigned Byte | Negotiated multiplexing count |
| Unsigned Byte | Negotiated encryption bits (e.g., 0, 40, 56, or 128) |
| Unsigned Long | Local RN (set to 0 if security not configured) |
| Integer | |
| 20 Unsigned Bytes | Recipient HASH (set to 0 if security not configured) |

The format of the OSI TP Data portion of the foregoing Security_Rsp message type in accordance with an embodiment of the invention is 20 Unsigned Bytes representing the Recipient HASH values. The format of the OSI TP data portion of the foregoing Abort message type in accordance with an embodiment of the invention is an Unsigned Byte representing the reason for the abort. There is no XATMI Encoding or user data portion for either the Security_Rsp or the Abort_Req message types. Exemplary Abort reason codes include: (1) invalid protocol version; (2) multiplexing negotiation error; (3) configuration error; (4) security error; (5) encryption negotiation error; (6) recovery not complete error; (7) RDOM is offline; (8) invalid platform; and (9) other error.

In addition to the foregoing message headers and formats, there are a number of novel PDU groupings that follow the header and length portions of the OSI TP messages in accordance with the invention. The PDUs associated with the establishment of dialogues in accordance with a preferred embodiment of the invention are illustrated below in Table 6. These messages have a message type of New_Dialogue(22). A TP-ID, comprising a multiplexed branch index and branch generation id placed into 32 bits, is sent to represent the branch for a new dialogue and a multiplexed branch_table is established to house resources for all concurrent branch activity, thereby enabling the response from a remote host to be linked back to the originating branch.

TABLE 6

| PDU | | |
|---|---|---|
| No. | PDU Name | Prior Art PDUs |
| 1 | p_tpcall_notran_ri | /* begin_dial_ri + data + |
| | | grant control */ |
| 2 | p_tpcall_noreply_ri | /* begin_dial_ri + data + |
| | | end dial */ |
| 3 | p_tpconnect_notran_sendonly_ri | /* begin_dial_ri + data */ |
| 4 | p_tpcall_tran_ri | /* begin_dial_ri + */ |
| | | /* c_begin_ri + defer_ri */ |
| | | /* data_ri + grant_control */ |
| 5 | p_tpconnect_tran_sendonly_ri | /* begin_dial_ri + */ |
| | | /* c_begin_ri + defer_ri */ |
| | | /* data_ri */ |
| 6 | p_tpcall_prepare_ri | /* begin_dial_ri + |
| | | c_begin_ri +u_ase_ri + |
| | | defer_ri + prepare_ri */ |

The format of the OSI TP Data portion of non-transactional messages (OSI TP PDUs 1-3 in Table 6 above) in accordance with an embodiment of the invention is set forth in Table 7 below. The XATMI Encoding with optional user data follows the OSI TP Data portion of the messages.

TABLE 7

| | |
|---|---|
| Unsigned Byte | OSI TP PDU Type |
| Unsigned Long Integer | Local TP_ID |
| Unsigned Long Integer | Timeout |
| 33 Unsigned Bytes | User ID (e.g., a null-terminated ASCII string) |

The format of the OSI TP Data portion of transactional messages (OSI TP PDUs 4-6 in Table 6 above) in accordance with an embodiment of the invention is set forth in Table 8 below. The XATMI Encoding with optional user data follows the OSI TP Data portion of the messages.

TABLE 8

| | |
|---|---|
| Unsigned Byte | OSI TP PDU Type |
| Unsigned Long Integer | Local TP_ID |
| Unsigned Long Integer | Timeout |
| 33 Unsigned Bytes | User ID (e.g., a null-terminated ASCII string) |
| Unsigned Byte | AAID Length (e.g., from 1 to 140) |
| Array of Unsigned Bytes | AAID |
| Unsigned Byte | BRID Length (e.g., from 1 to 140) |
| Array of Unsigned Bytes | BRID |

Other novel PDU groupings that follow the header and length portions of the OSI TP messages in accordance with an embodiment of the invention are listed in Table 9 below. Unlike the PDUs listed in Table 6 above, the PDUs listed in Table 9 below are not associated with the establishment of dialogues. These messages have a message type of Data(23).

TABLE 9

| PDU No. | PDU Name | Prior Art PDUs |
|---|---|---|
| 7 | p_bdrc_tpreturn_notran | /* begin_dial_rc */ |
| | | /* data_ri + end_dial_ri */ |
| 8 | p_bdrc_tpsend_rcvonly | /* tp_begin_dialogue_rc */ |
| | | /* data_ri + */ |
| | | /* tp_grant_control_ri */ |
| 9 | p_bdrc_tpsend_sendonly | /* tp_begin_dialogue_rc */ |
| | | /* data_ri */ |
| 10 | p_bd_rc | /* begin_dialogue_rc */ |
| 11 | p_bdc_rc | /* begin_dialogue_rc + c_begin_rc */ |
| 12 | p_bdc_rc_tpsend_sendonly_ri | /* begin dialogue rsp/w */ |
| | | /* c-begin + data req */ |
| 13 | p_bdc_rc_tpsend_rcvonly_ri | /* begin_dialogue cnfw */ |
| | | /* c-begin cnf + data req */ |
| | | /* grant_control req */ |
| 14 | p_bdc_rc_tpsend_ready_ri | /* begin_dialogue_rc + c_begin_rc + |
| | | u_ase_ri + c_ready_ri */ |
| 15 | p_tpsend_rcvonly | /* u_ase_ri + */ |
| | | /* grant_control_ri */ |
| 16 | p_tpreturn_notran | /* u_ase_ri + */ |
| | | /* end_dialogue_ri */ |
| 17 | p_tpreturn_ready | /* data_ri + ready_ri */ |
| 18 | p_tpsend_sendonly | /* u_ase_apdu_type */ |
| 19 | p_bdrc_rollback_ri | /* c_rb_ri (bd_rc) */ |
| 20 | p_bdrc_rollback_rc | /* c_rb_rc (bd_rc) */ |
| 21 | p_bdrc_abort_ri | /* bd_rc + tp_abort_ri */ |
| 22 | unused | |
| 23 | p_bdri_channel | /* tp_begin_dialogue_ri */ |
| | | /* for channels */ |
| 24 | p_prepare_ri | /* tp_prepare_ri */ |
| 25 | p_ready_ri | /* c_ready_ri */ |
| 26 | p_commit_ri | /* c_commit_ri */ |
| 27 | p_commit_rc | /* c_commit_rc */ |
| 28 | p_rollback_ri | /* c_rollback_ri */ |
| 29 | p_rollback_rc | /* c_rollback_rc */ |
| 30 | p_recover_ri | /* tp_recover_ri */ |
| 31 | p_recover_rc | /* c_recover_rc */ |
| 32 | p_bdrc_channel | /* bd_rc for channels */ |
| 33 | p_pabort_ri | /* provider abort */ |
| 34 | p_aabort_ri | /* connection closed */ |
| 35 | p_uabort_ri | /* user abort */ |
| 36 | p_tp_abort_rollback_ri | /* c_rollback_ri (abort) */ |
| 37 | p_tp_abort_rollback_rc | /* c_rb_rc(abort) */ |
| 38 | p_tp_heurpt_commit_rc | /* c_commit_rc (heur) */ |
| 39 | p_tp_heurpt_rollback_rc | /* c_rb_rc(heur) */ |
| 40 | p_tp_heurpt_recover_rc | /* c_recover(tp_heur_rep) */ |
| 41 | p_tp_abort_heurpt_rollback_ri | /* c_rb_ri(abort w/heur) */ |
| 42 | p_tp_abort_heurpt_rollback_rc | /* c_comm_ri(ab w/heur) */ |

The multiplexed protocol in one embodiment of the invention uses the following values for Heuristic Type: no_heuristic=0; heuristic_mix=1; and heuristic_hazard=2.

The format of the OSI TP Data portion of begin dialogue response with data messages or begin dialogue response with an abort messages (OSI TP PDUs 7-9, 12-14, 21-22, and 35-36 in Table 9 above) in accordance with an embodiment of the invention is set forth in Table 10 below. The XATMI Encoding with optional user data follows the OSI TP Data portion of the messages. In the case of PDU 36, the XATMI Encoding may be zero length.

TABLE 10

| | |
|---|---|
| Unsigned Byte | OSI TP PDU Type |
| Unsigned Long Integer | Recipient TP_ID |
| Unsigned Long Integer | Local TP_ID |

The format of the OSI TP Data portion of an abort without XATMI data (OSI TP PDUs 33 and 34 in Table 9 above) in accordance with an embodiment of the invention is set forth in Table 11 below. There is no XATMI Encoding or user data that follows the OSI TP Data portion of the messages.

TABLE 11

| | |
|---|---|
| Unsigned Byte | OSI TP PDU Type |
| Unsigned Long Integer | Recipient TP_ID |
| Unsigned Long Integer | Local TP_ID |

The format of the OSI TP Data portion of a begin dialogue with a dialogue result (OSI TP PDUs 10-11, 19, 23, and 32 in Table 9 above) in accordance with an embodiment of the invention is set forth in Table 12 below. There is no XATMI Encoding or user data that follows the OSI TP Data portion of the messages.

TABLE 12

| | |
|---|---|
| Unsigned Byte | OSI TP PDU Type |
| Unsigned Long Integer | Recipient TP_ID |
| Unsigned Long Integer | Local TP_ID |
| Unsigned Byte | Dialogue Result (e.g., accept or reject) |

The format of the OSI TP Data portion of a user data request (OSI TP PDUs 15-18 in Table 9 above) in accordance with an embodiment of the invention is set forth in Table 13 below. The XATMI Encoding with optional user data follows the OSI TP Data portion of the messages.

TABLE 13

| | |
|---|---|
| Unsigned Byte | OSI TP PDU Type |
| Unsigned Long Integer | Recipient TP_ID |

The format of the OSI TP Data portion of a two-phased commit message with a recipient (OSI TP PDUs 20, 24-29 and 37 in Table 9 above) in accordance with an embodiment of the invention is set forth in Table 14 below. There is no XATMI Encoding or user data that follows the OSI TP Data portion of the messages.

TABLE 14

| | |
|---|---|
| Unsigned Byte | OSI TP PDU Type |
| Unsigned Long Integer | Recipient TP_ID |

The format of the OSI TP Data portion of a recover message (OSI TP PDU 30 in Table 9 above) in accordance with an embodiment of the invention is set forth in Table 15 below. There is no XATMI Encoding or user data that follows the OSI TP Data portion of the messages.

TABLE 15

| | |
|---|---|
| Unsigned Byte | OSI TP PDU Type |
| Unsigned Long Integer | Recipient TP_ID |
| Unsigned Long Integer | Local TP_ID |
| Unsigned Byte | Recover Type (e.g., commit, ready, unknown, |
| | done, retry_later) |
| Unsigned Byte | AAID Length (e.g., from 1 to 140) |
| Array of Unsigned Bytes | AAID |
| Unsigned Byte | BRID Length (e.g., form 1 to 140) |
| Array of Unsigned Bytes | BRID |

The format of the OSI TP Data portion of a recover response message (OSI TP PDU 31 in Table 9 above) in accordance with an embodiment of the invention is set forth in Table 16 below. There is no XATMI Encoding or user data that follows the OSI TP Data portion of the messages.

TABLE 16

| | |
|---|---|
| Unsigned Byte | OSI TP PDU Type |
| Unsigned Long Integer | Recipient TP_ID |
| Unsigned Long Integer | Local TP_ID |
| Unsigned Byte | Recover Type (e.g., commit, ready, unknown, |
| | done, retry_later) |

The format of the OSI TP Data portion of a heuristic commit or rollback message (OSI TP PDUs 38-39 in Table 9 above) in accordance with an embodiment of the invention is set forth in Table 17 below. There is no XATMI Encoding or user data that follows the OSI TP Data portion of the messages.

TABLE 17

| | |
|---|---|
| Unsigned Byte | OSI TP PDU Type |
| Unsigned Long Integer | Recipient TP_ID |
| Unsigned Byte | Heuristic Type (e.g., heuristic_mix, |
| | heuristic_hazard) |

The format of the OSI TP Data portion of a heuristic recover message (OSI TP PDU 40 in Table 9 above) in accordance with an embodiment of the invention is set forth in Table 18 below. There is no XATMI Encoding or user data that follows the OSI TP Data portion of the messages.

TABLE 18

| | |
|---|---|
| Unsigned Byte | OSI TP PDU Type |
| Unsigned Long Integer | Recipient TP_ID |
| Unsigned Long Integer | Local TP_ID |
| Unsigned Byte | Heuristic Type (e.g., heuristic_mix, |
| | heuristic_hazard) |
| Unsigned Byte | Recover Type (e.g., unknown, done) |

The format of the OSI TP Data portion of a rollback abort with heuristic message (OSI TP PDUs 41-42 in Table 9 above) in accordance with an embodiment of the invention is set forth in Table 19 below. The XATMI Encoding with optional user data follows the OSI TP Data portion of the messages, but the XATMI Encoding may be zero length.

TABLE 19

| | |
|---|---|
| Unsigned Byte | OSI TP PDU Type |
| Unsigned Long Integer | Recipient TP_ID |
| Unsigned Byte | Heuristic Type (e.g., heuristic_mix, |
| | heuristic_hazard) |

While the invention has been described in connection with the embodiments depicted in the various figures, it is to be understood that other embodiments may be used or modifications and additions may be made to the described embodiments without deviating from the spirit of the invention. Therefore, the invention should not be limited to any single embodiment whether depicted in the figures or not. Rather, the invention should be construed to have the breadth and scope accorded by the claims appended below.

1. In an environment for performing distributed transaction processing via data contained in messages exchanged between heterogeneous computer systems, a message format wherein each message exchanged comprises a plurality of fields, and the fields comprise at least a message type field, a message length field, and a fixed set of fields dictated by the message type.

2. The message format of claim 1 wherein each message exchanged has a fixed number of parameters.

3. The message format of claim 1 wherein each message field has a fixed number of bytes.

4. The message format of claim 1 wherein each message comprises a stream of bytes without regard to word alignment within the message.

5. The message format of claim 1 wherein the message fields comprise a plurality of logical field types including an unsigned byte, an array of unsigned bytes, an unsigned short integer, and an unsigned long integer.

6. The message format of claim 1 wherein each message exchanged has the general format of a Header followed by OSI TP Data, XATMI Encoding following the OSI TP Data, and user data following the XATMI Encoding, the message type and data length fields being comprised of the Header, and the data field being comprised of the OSI TP Data, XATMI Encoding, and user data.

7. The message format of claim 6 wherein the Header comprises an unsigned byte for the message type field and an unsigned long integer for the data length field.

8. The message format of claim 6 wherein the XATMI Encoding comprises an unsigned long integer indicating length of XATMI data in the message and an array of unsigned bytes comprising the XATMI data.

9. The message format of claim 1 wherein there are at least nine message type fields.

10. The message format of claim 1 wherein the message type fields comprise Keep_Alive, Keep_Alive_Ok, Associate_Req, Associate_Rsp, Security_Rsp, Security_Ok, New_Dialogue, Data, and Abort_Req.

11. In an environment for performing distributed transaction processing via exchange of messages containing data in the form of OSI TP PDUs, a plurality of PDU types comprising groups of the OSI TP PDUs, each of the PDU types characterizing the data contained in each of the OSI TP PDU groups.

12. The PDU types of claim 11 wherein each type has a numeric value.

13. The PDU types of claim 12 wherein each numeric value is unique.

14. The PDU types of claim 11 wherein an XATMI API is utilized as an AP-CRM interface in the distributed transaction processing environment.

15. The PDU types of claim 14 wherein there are at least forty-one PDU types.

16. The PDU types of claim 14 wherein there are at least six PDU types associated with the establishment of OSI TP dialogues.

17. The PDU types of claim 16 wherein the at least six PDU types comprise p_tpcall_notran_ri, p_tpcall_noreply_ri, p_tpconnect_notran_sendonly_ri, p_tpcall_tran_ri, p_tpconnect_tran_sendonly_ri, and p_tpcall_prepare_ri.

18. The PDU types of claim 14 comprising p_bdrc_tpreturn_notran, p_bdrc_tpsend_rcvonly, p_bdrc_tpsend_sendonly, p_bd_rc, p_bdc_rc, p_bdc_rc_tpsend_sendonly_ri, p_bdc_rc_tpsend_rcvonly_ri, p_bdc_rc_tpsend_ready_ri, p_tpsend_rcvonly, p_tpreturn_notran, p_tpreturn_ready, p_bdrc_abort_ri, and p_bdri_channel.

19. An apparatus for participating in distributed transaction processing via exchange of messages between peer processing machines, comprising a first peer processing machine running executable code capable of establishing a multiplexed TCP/IP connection with a second peer processing machine and exchanging messages with the second peer processing machine over the multiplexed TCP/IP connection.

20. The apparatus of claim 19 wherein a plurality of concurrent OSI TP dialogues reside on the first peer processing machine, and each of the concurrent OSI TP dialogues are mapped by the first peer processing machine into the multiplexed TCP/IP connection.

21. The apparatus of claim 19 wherein the first peer processing machine utilizes a multiplexed communications instance with the multiplexed TCP/IP connection.

22. The apparatus of claim 21 wherein the multiplexed communications instance includes state information about the multiplexed TCP/IP connection.

23. The apparatus of claim 21 wherein the multiplexed communications instance includes information for establishing communications with, sending data to, and receiving data from the second peer processing machine.

24. The apparatus of claim 19 wherein the first peer processing machine utilizes a multiplexed branch data structure with the multiplexed TCP/IP connection.

25. The apparatus of claim 24 wherein the multiplexed branch data structure includes a pointer to another data structure for queuing output requests and posting network aborts generated by the first peer processing machine, decoded fields for placing flags or other information discovered by the first processing machine while decoding a message; and a unique identification number comprised of a branch and generation id for the second peer processing machine.

26. The apparatus of claim 19 wherein a plurality of threads are utilized by the first peer processing machine to establish and manage the multiplexed TCP/IP connection.

27. The apparatus of claim 26 wherein the plurality of threads comprise a timer thread, socket listener thread, socket worker thread, socket input thread, and socket output thread.

28. The apparatus of claim 27 wherein the socket input thread controls a communications instance array and a poll array in the first peer processing machine.

29. The apparatus of claim 27 wherein the socket output thread controls data output by a protocol machine in the first peer processing machine and destined for the output socket thread.
